(19) United States
(12) Patent Application Publication
(10) Pub. No.: US 2018/0114152 A1
(43) Pub. Date: Apr. 26, 2018

(54) Data Processing System And Method

(71) Applicant: Alacrity Renovation Services LLC, Eugene, OR (US)

(72) Inventor: Warren D. Erickson, Suwanee, GA (US)

(21) Appl. No.: 15/844,134

(22) Filed: Dec. 15, 2017

Related U.S. Application Data
(63) Continuation of application No. 12/077,053, filed on Mar. 14, 2008, now abandoned.
(60) Provisional application No. 60/918,213, filed on Mar. 14, 2007.

(51) Int. Cl. G06Q 10/06

(52) U.S. Cl. CPC G06Q 10/06; G06Q 10/06311

(57) ABSTRACT

A job assignment is received into a portable device. A job site associated with the job assignment is diagrammed using the portable device. Job site readings are also entered into the portable device. The portable device then displays an indication of at least one piece of equipment needed at the job site and communicates the job site diagram and job site readings to a database.

### RELATED APPLICATIONS

This application is a continuation of U.S. application Ser. No. 12/077,053, entitled “Data Processing System and Method,” filed Mar. 14, 2008, the disclosure of which is incorporated by reference herein in its entirety.

This application also claims the benefit of U.S. Provisional Application No. 60/918,213, filed Mar. 14, 2007, the disclosure of which is incorporated by reference herein.

### TECHNICAL FIELD

The present invention relates to the collection and distribution of data, such as via a portable device.

### BACKGROUND

Collecting and updating data from a specific location, such as a job site, is important in many situations. For example, data collection and management is important when monitoring the status of a job site that requires the performance of a particular action, such as a job site repair, maintenance, or other activity that is performed over a period of time. The data collection and management operations can include identifying the original status of the job site, determining one or more actions to be performed at the job site, and monitoring certain changes at the job site as the activity is performed.

In many situations, multiple users and systems are involved in monitoring the status of a particular action. These users and systems typically desire the most current information available for a particular action being monitored. If these users and systems do not receive timely information about the monitored action, there may be an adverse result on the performance of the action. For example, an action may not be performed as quickly or as efficiently as possible, if information about the action is not communicated in a timely manner. In another example, mold may begin growing if water damage is not managed in a timely manner.

Thus, it is valuable to provide a system that collects and distributes data in a timely manner to the systems and users that utilize the data.

### BRIEF DESCRIPTION OF THE DRAWINGS

Similar reference numbers are used throughout the figures to reference like components and/or features.

FIG. 1 illustrates an example environment in which the data processing systems and methods discussed herein can be implemented.

FIG. 2 is a block diagram of an example portable device capable of collecting and processing data as discussed herein.

FIGS. 3 and 4 are flow diagrams illustrating example procedures for processing data.

FIGS. 5A-5C illustrate example graphical interface screens displayed on a portable device.

FIG. 6 is a block diagram illustrating an example computing device.

### DETAILED DESCRIPTION

The systems and methods described herein manage various types of data associated with job sites and similar locations. In particular, the disclosed systems and methods collect data associated with the initial status of a job site, identify one or more actions to perform at the job site, and monitor the status of the job site as the actions are performed at the job site.

A particular example discussed herein refers to the management of data at a job site requiring mitigation of water damage. In this example, the job site is typically a building that has suffered some type of water damage that requires mitigation. The initial status of the job site includes information such as the air temperature, air humidity, photographs, and related data associated with the job site. This initial status is used to determine the types of mitigation activities that are necessary to mitigate the water damage. These mitigation activities may include the use of dehumidifiers and air movers, application of anti-microbial products, and the like. This example is provided for purposes of illustration. The systems and methods described herein can be applied to any type of data management situation.

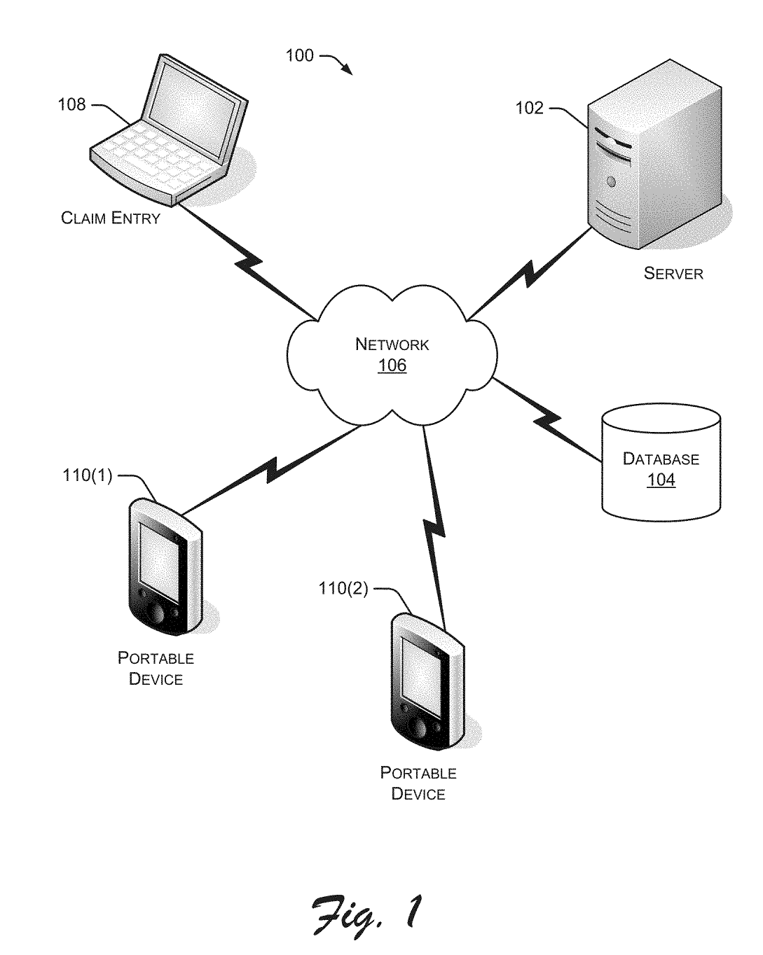

FIG. 1 illustrates an example environment 100 in which the data processing systems and methods discussed herein can be implemented. Environment 100 includes a server 102 and a database 104 coupled to one another via a data communication network 106. Server 102 provides various data management activities, such as receiving insurance claim information, analyzing job site data, recommending necessary activities based on the job site data, monitoring the progress of activities at job sites, determining changes to the job site activities being performed, and estimating mitigation costs and processing times associated with a particular job site project. Server 102 may also perform additional functions related to data processing and other tasks.

Database 104 stores various data, such as job site data, insurance claim data, guidelines for mitigating water damage, and the like. In a particular embodiment, database 104 stores a log of data associated with the drying process performed at a particular location. Although database 104 is shown in FIG. 1 as being accessible via network 106, in alternate embodiments, database 104 may also be connected directly to server 102 and/or other computing devices. Network 106 is a data communication network capable of communicating data between devices coupled to the network. Network 106 may utilize any data communication protocol across any type of medium. In a particular embodiment, network 106 is the Internet. In other embodiments, network 106 is a combination of one or more networks, such as wide area networks, local area networks, and the like.

Environment 100 also includes a claim entry device 108, and multiple portable devices 110, all of which are coupled to network 106. Claim entry device 108 communicates with server 102 and database 104 to enter data regarding a claim (or project), such as a water mitigation claim. Claim entry device 108 typically enters job site data (e.g., job site location, type of structure, and types of services desired) and information regarding the origin of the claim. Claim entry device 108 can be any type of computing device capable of communicating with network 106, such as a desktop computer, a laptop computer, a portable computing device, and the like. Portable devices 110 communicate data from a job site or other remote location to server 102 and database 104 via network 106. Example portable devices 110 include portable computing devices, cellular phones, and any other device capable of communicating with network 106. As discussed in greater detail below, each portable device 110 is capable of executing one or more applications and/or algorithms that process data and make recommendations associated with a job site, project, or other environment.

The illustration in FIG. 1 is provided as an example. A particular environment 100 may include any number of servers 102, databases 104, claim entry devices 108, and portable devices 110 coupled to one another via any number of data communication networks and other communication mechanisms. Environment 100 may include additional devices not shown in FIG. 1, and may eliminate one or more devices shown in FIG. 1.

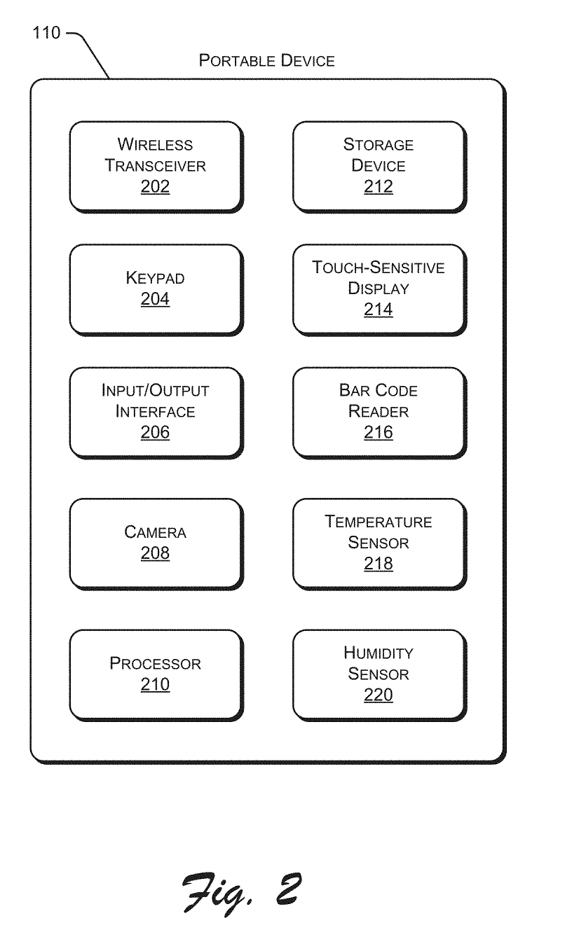

FIG. 2 is a block diagram of an example portable device capable of collecting and processing data as discussed herein. Portable device 110 includes a wireless transceiver 202, a keypad 204, an input/output interface 206, and a camera 208. Wireless transceiver 202 provides data communication with other devices and networks, such as network 106 shown in FIG. 1. Example wireless transceivers communicate via wi-fi, cellular, or other data communication mechanism. Keypad 204 allows a user of portable device 110 to enter data and other information to the device. Input/output interface 206 is another mechanism for exchanging data between portable device 110 and other devices, networks, or systems. In one embodiment, input/output interface 206 is a universal serial bus (USB) interface. Camera 208 allows a user to take photographs that are stored in the portable device. These photographs can be communicated to other devices via wireless transceiver 202 or input/output interface 206.

Portable device 110 also includes a processor 210, a storage device 212, and a touch-sensitive display 214. Processor 210 performs various operations to implement the features of portable device 110. Storage device 212 includes one or more volatile and/or non-volatile memory devices. Storage device 212 is capable of storing data received or created by portable device 110. Touch-sensitive display 214 displays information to the user of portable device 110 and provides a mechanism for the user to input data by selecting one or more entries on the display. User input of data via touch-sensitive display 214 may be performed at the same time as entering data through key pad 204.

Portable device 110 further includes a bar code reader 216, a temperature sensor 218, and a humidity sensor 220. Bar code reader 216 allows a user of portable device 110 to input information contained in a bar code into the portable device. Temperature sensor 218 is capable of sensing the temperature of the air proximate portable device 110. The data associated with the sensed temperature is stored, for example, in storage device 212. Humidity sensor 220 is capable of sensing the humidity of the air proximate the portable device 110. The humidity data is stored, for example, in storage device 212. In alternate embodiments, portable device 110 does not include temperature sensor 218 and humidity sensor 220. In this embodiment, the temperature and humidity readings are obtained from another device and entered into portable device 110 using, for example, key pad 204.

In alternate embodiments of portable device 110, additional components may be added to the device and one or more components shown in FIG. 2 may be removed from the device. For example, temperature sensor 218 and humidity sensor 220 may be removed from certain embodiments of portable device 110. Additionally, an audio speaker, a radio-frequency id (RFID) reader, and other environmental sensors may be added to specific embodiments of portable device 110.

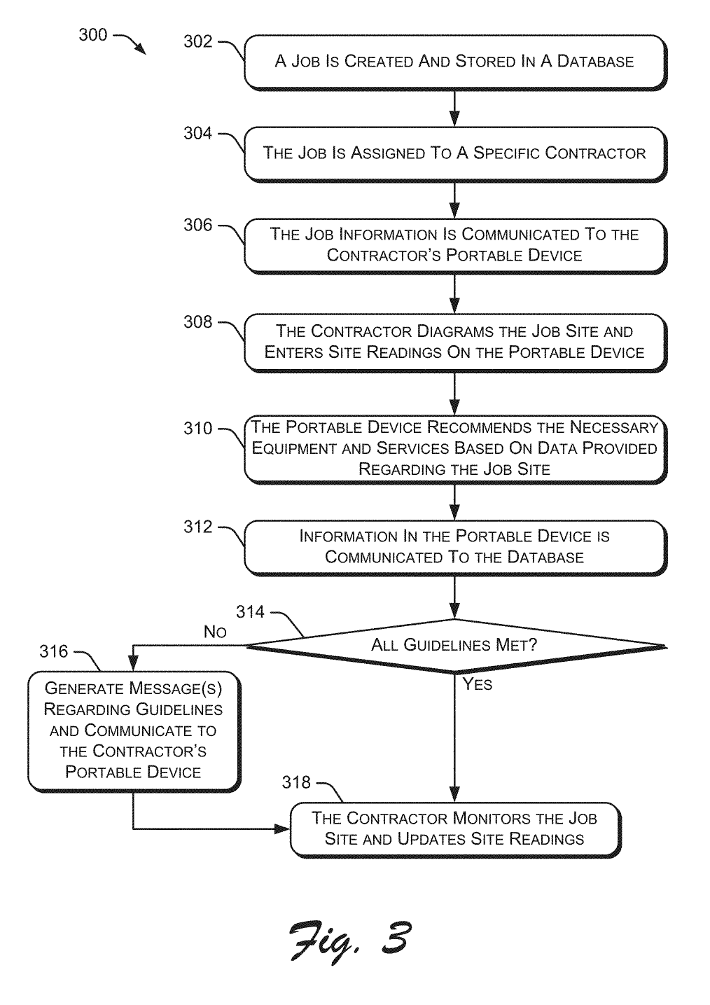

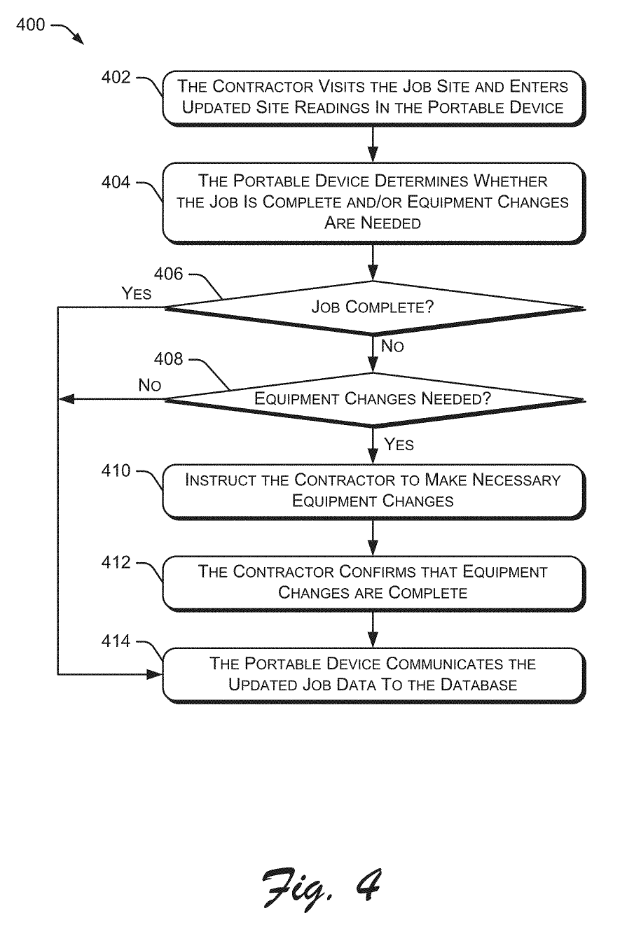

FIGS. 3 and 4 are flow diagrams illustrating example procedures for processing data. Referring to FIG. 3, a procedure 300 begins when a job is created and stored in a database (block 302). A job may be created, for example, by a representative of an insurance provider or other entity defining the scope of work associated with a particular job. Next, the job is assigned to a specific contractor (block 304). In a particular embodiment, jobs are assigned to contractors on a rotating basis—selecting from among active contractors in the same geographic area as the job. The job information is then communicated to the contractor's portable device (block 306) via a wireless communication link, such as network 106 shown in FIG. 1.

After the contractor receives the job information, the contractor visits the job site and collects data regarding the job site and the activities to be performed. For example, the contractor diagrams the job site using the portable device and enters site readings into the portable device (block 308). Example user interface screens for diagramming the job site using the portable device are provided below. The process of diagramming the job site includes providing room dimensions, material types, and related information that is later used to determine the equipment and services needed to properly complete the job. Entering site readings includes entering temperature, humidity, and other environmental data into the portable device. Site readings may also include moisture levels in the floor, walls, and ceiling. Typically, temperature and humidity readings are recorded for the affected area as well as the unaffected area (e.g., the area not being treated). In certain embodiments, the portable device uses built-in sensors to determine temperature, humidity, and other site readings. The contractor may also take one or more photographs of the job site using camera 208 contained in portable device 110.

After the contractor has entered the site data discussed above, the portable device recommends the necessary equipment and services to complete the job (block 310). For example, in the case of a job related to water damage, the portable device will recommend one or more dehumidifiers depending on the size of the room and the initial humidity levels. One or more additional services may also be recommended, such as application of an anti-microbial product. In this example, when calculating the equipment needed for a particular job, the portable device uses information provided by the Institute of Inspection, Cleaning and Restoration Certification (IICRC).

Procedure 300 continues by communicating the job information stored in the portable device to the database (block 312). If portable device 110 is able to communicate with network 106, the job information is communicated shortly after entry into the portable device. However, if portable device 110 is not within communication range of network 106, the job information is communicated to the database at a later time when the portable device is able to communicate with the database via network 106.

By communicating the job information to the database, other web-based applications (discussed below) can access the same information, thereby allowing all users associated with the job to obtain the current job information. For example, certain applications graphically display a drying process over a period of time by monitoring data on a daily basis. The graphical display can be a bar graph, line graph, or any other visual representation of the drying process. Other applications verify that the type and quantity of equipment at the job site can accomplish the job. Applications may also generate an initial job cost estimate and determine whether additional services are needed to properly complete the job.

Next, the procedure determines whether the equipment currently operating at the job site meets all guidelines for accomplishing the job (block 314). This determination can be performed by the portable device and/or a server or other device that has access to the database containing the job information. If the guidelines (e.g., the IICRC guidelines) are not satisfied, one or more messages are generated identifying the guidelines that are not satisfied (block 316). These messages are displayed on the contractor's portable device and also displayed to other users or systems associated with the job. The messages indicate why the guidelines are not satisfied and may make recommendations for complying with the guidelines. By notifying the contractor of unmet guidelines while the contractor is still on the job site allows the contractor to make changes to the equipment before leaving the job site.

If all guidelines are satisfied at block 314, the contractor continues monitoring the job site and updates site readings as needed (block 318). The contractor may monitor the job site on a daily basis or other schedule depending on the specifics of the job.

For example, at a particular job site the IICRC guidelines may recommend daily readings of temperature and humidity at the job site. The guidelines may also recommend movement of drying equipment to achieve the intended drying results (i.e., the “drying goals”). These drying goals may be established based on readings taken in unaffected areas of the job site at the time of the initial visit by the contractor. Drying goals are typically a combination of temperature, humidity, and moisture content readings taken in unaffected areas of the job site, or otherwise defined. Portable device 110 is useful in monitoring a specific drying process by comparing current readings with previous days readings to display drying progress and assist the contractor in changing the equipment mix and/or changing the location of the equipment at the job site.

In a particular implementation, portable device 110 includes a bar code reader 216, as discussed above with respect to FIG. 2. Additionally, each piece of equipment at the job site has an attached bar code that identifies the piece of equipment and its functional capabilities. For example, the bar code may indicate a specific model of dehumidifier—that model of dehumidifier has known functional capabilities (such as drying capacity), such as its ability to remove humidity from the air. The model of dehumidifier may also be rated for dehumidifying a particular volume of air in a specific period of time, depending on various environmental conditions. Thus, the contractor can scan the bar code on each piece of equipment being used on the job site using the bar code reader in portable device 110 rather than manually entering the equipment information through the key pad on the portable device.

By pre-assigning bar codes to every type of equipment available in the marketplace, the contractor can get immediate feedback via portable device 110 regarding whether the currently installed equipment is sufficient for the job. Additionally, the systems and methods described herein permit the tracking of equipment usage over a particular time period, such as a month. The described systems and methods can generate a usage report identifying the number of days each piece of equipment was being used and the number of days each piece of equipment was idle.

Referring to FIG. 4, a procedure 400 begins when a contractor visits the job site to update site readings (block 402). The updated site readings will vary depending on the job requirements. In a particular example, updated site readings may include current air temperature and current humidity level. Based on the updated site readings, the portable device determines whether the job is complete or whether any equipment changes are necessary (block 404). If the job is complete (e.g., the humidity levels are within the normal range for the job site), the procedure branches to block 414, where the portable device communicates the updated job site data to the database. When the job is complete, the homeowner or business owner can indicate their acceptance of the work by signing on the display screen of portable device 110. The signature is captured and stored in portable device 110. If the job is not complete, but no equipment changes are necessary, procedure 400 also branches to block 414.

If equipment changes are necessary, the procedure continues to block 410, where the contractor is instructed to make the necessary equipment changes. These equipment changes include adding new equipment, removing existing equipment, or replacing an existing equipment with different equipment. For example, an additional dehumidifier may be required or the positioning of existing dehumidifiers may be modified. Next, the contractor confirms that the equipment changes have been completed (block 412). The portable device then communicates the updated job site data to the database (block 414). If the job is not yet complete, procedure 400 is repeated when the contractor makes the next visit to the job site to update site readings.

The systems and methods described herein also permit the creation and ongoing modification of job cost estimates. For example, by tracking the equipment being used at a job site, the daily rental costs or other fees associated with the equipment is easily monitored. Additional expenses (e.g., anti-microbial treatments and movement of furniture) are also monitored and used to update the job cost estimate. Thus, a user (e.g., a customer or user initiating the job) can determine the current job costs as well as the total estimated costs for the entire job. When the job is finished, the final readings are entered into portable device 110 and uploaded to database 104. At this point, the system automatically generates an invoice for the job and forwards the invoice to the customer or person initiating the job.

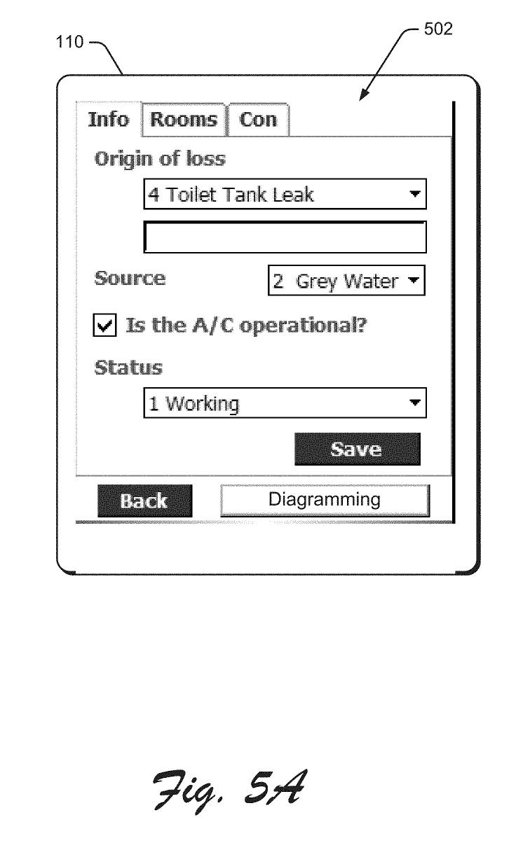

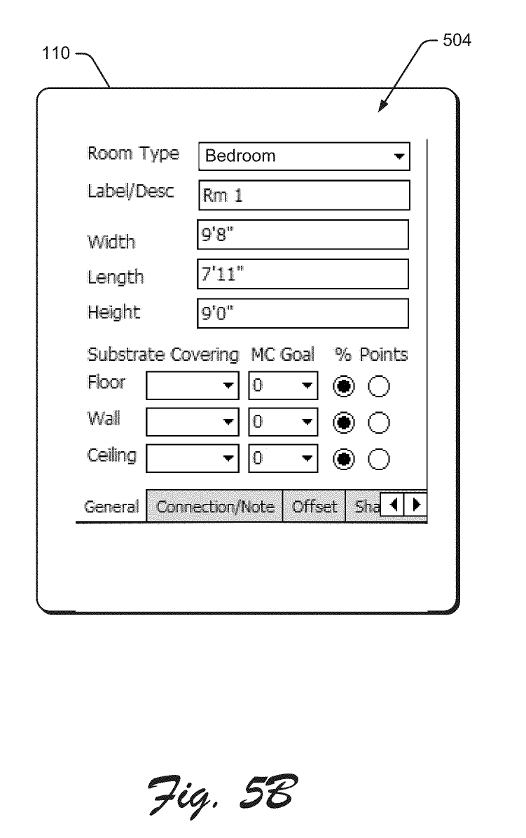

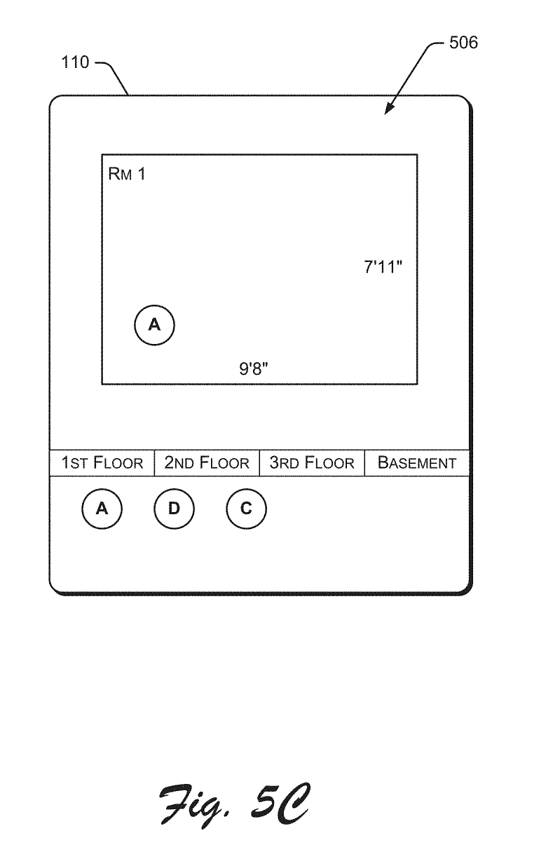

FIGS. 5A-5C illustrate example graphical interface screens displayed on portable device 110. FIG. 5A illustrates an example graphical interface screen 502 that allows a user of portable device 110 to enter information regarding the job. For example, graphical interface screen 502 allows a user to enter the origin of the problem or job, the status of the job, whether air conditioning is operational at the job site, and so forth.

FIG. 5B illustrates an example graphical interface screen 504 that allows a user of portable device 110 to enter information regarding a specific room being managed as part of the job. As shown in FIG. 5B, room-related data may include room dimensions, substrate coverings, and job-related goals, such as drying goals. Similar data is entered for each room affected by the water damage or other problem being mitigated. After the room dimensions and other information has been entered into portable device 110, the portable device calculates other information, such as the square footage of the room, cubic volume of the room, linear perimeter of the room, and so forth.

FIG. 5C illustrates an example graphical interface screen 506 that allows a user of portable device 110 to diagram a particular room and identify the placement of equipment within the room. Graphical interface screen 506 permits a user to drag-and-drop equipment icons in the rooms to indicate equipment location. For example, icon “A” represents an air mover, icon “D” represents a dehumidifier, and icon “C” represents a cavity dryer. As discussed above, each piece of equipment has a bar code, which identifies the type of equipment and its functional capabilities. The user of portable device 110 scans each piece of equipment in a particular room, then indicates the position of the equipment using graphical interface screen 506. Once the equipment information is communicated to database 104, supervisors or other users can monitor equipment placement, drying progress, and the like. Supervisors and other users can make suggestions regarding equipment used and equipment placement if the job is not drying properly without having to physically visit the job site.

Although not shown in FIG. 5C, additional icons and buttons may be displayed on graphical interface screen 506. These additional icons and buttons are associated with, for example, other types of equipment, drawing tools, and a notation tool for adding text notes to the diagram.

The various data entered via one or more graphical interface screens is applied to one or more drying algorithms to generate suggestions and identify industry guidelines regarding the drying job. In one implementation, guidelines and algorithms provided by the IICRC are used to determine proper equipment and activities for a specific job site. Example algorithms are psychrometric algorithms that deal with measuring the thermodynamic properties of air and water vapor mixtures. These algorithms help determine the proper equipment types and quantities to achieve the desired results, such as reducing the relative humidity in affected rooms.

Example algorithms for determining the number of air movers and dehumidifiers needed for a particular job are discussed below. These example algorithms are based upon recommended equipment usage published in the IICRC Standard and Reference Guide for Professional Water Damage Restoration (IICRC S500). In these examples, different algorithms are used depending on the “Class” of damage or loss. Those Classes of water damage/loss are defined by the IICRC S500 as:

Class 1 (least amount of water, absorption, and evaporation): Water losses that affect only part of a room or area, or larger areas containing materials that have absorbed minimal moisture. Little or no wet carpet and/or cushion is present.

Class 2 (large amount of water, absorption, and evaporation): Water losses that affect at least an entire room of carpet and cushion (pad). Water has wicked up walls less than 24 inches. There is moisture remaining in structural materials; e.g., plywood, particle board, structural wood, VCT, concrete and substructure soil.

Class 3 (greatest amount of water, absorption, and evaporation): Water may have come from overhead. Ceilings, walls, insulation, carpet, cushion and subfloor in virtually the entire area are saturated.

Class 4 (special drying situations): These consist of wet materials with very low permeance/porosity (e.g., hardwood, plaster, brick, concrete, light weight concrete and stone). Typically, there are deep pockets of saturation, which require very low specific humidity. These types of losses may require longer drying times and special methods.

Example algorithms include:
Air Movers: An example algorithm determines the minimum and maximum acceptable number of air movers/cavity dryers for a particular room.
   Damage Class 1:
      Minimum Count=Room Square Footage divided by 300 (rounded down to the nearest integer).
      Maximum Count=Room Square Footage divided by 250 (rounded up to the nearest integer).
   Damage Class 2, 3, 4:
      Minimum Count=Lesser of Room Square Footage divided by 60 and Room Perimeter divided by 16 (rounded down to the nearest integer).
      Maximum Count=Greater of Room Square Footage divided by 50 and Room Perimeter divided by 10 (rounded up to the nearest integer).
Dehumidifiers: An example algorithm determines the adequacy of dehumidification by determining the effective cubic footage of drying capability for the equipment listed in a particular room.

Table 1 below is used to determine the “Dehumidification Factor”, which is used in the calculations below.

TABLE 1

| Type | Class 1 | Class 2 | Class 3 | Class 4 |
|---|---|---|---|---|
| Refrigerant | 100 | 40 | 30 | N/A |
| LGR | 100 | 50 | 40 | 50 |
| Desiccant | 1 | 2 | 3 | 2 |

Refrigerant/LGR Dehumidifier:
   Cubic Foot Capacity=AHAM (Assoc. of Home Appliance Manufacturers) Rating multiplied by the Dehumidification Factor
Desiccant Dehumidifier:
   Cubic Foot Capacity=Process CFM (cubic feet per minute) divided by the Dehumidification Factor multiplied by 60
Adequacy Test:
   Minimum Cubic Feet=Room Cubic Feet
   Maximum Cubic Feet=Room Cubic Feet plus smallest Cubic Foot Capacity of all dehumidifiers listed

When drying multiple connected areas, a “Linked Volume” includes all linked rooms and their room additions. The “Dehumidification Factor” shown above in Table 1 is also used for linked rooms.
Refrigerant/LGR Dehumidifier:
   Cubic Foot Capacity=AHAM Rating multiplied by the Dehumidification Factor
Desiccant Dehumidifier:
   Cubic Foot Capacity=Process CFM divided by the Dehumidification Factor multiplied by 60
Adequacy Test:
   Minimum Cubic Feet=Link Cubic Feet
   Maximum Cubic Feet=Link Cubic Feet plus smallest Cubic Foot Capacity of all dehumidifiers listed

In a particular embodiment, if the contractor leaves the job site without activating sufficient equipment (based on industry guidelines and algorithms applied by portable device 110 or server 102), the contractor must explain why the industry guidelines were not satisfied. This explanation may include a lack of appropriate equipment during the initial visit or other factors.

Table 2 below identifies example data and other information used by one embodiment of the systems and methods discussed herein.

TABLE 2

| Category | Data |
|---|---|
| Claim Information | Claim ID |
| | Insured Claim Number |
| | Loss Description |
| Insured Information | Name |
| | Address |
| | City, State, Zip Code |
| | Phone Number |
| Origin of Loss | Toilet Supply |
| | Refrigeration Supply |
| | Water Tank Supply |
| | Toilet Tank Leak |
| | Toilet Overflow |
| | Tub Drain Leak |
| | Other |
| Source | Clean Water |
| | Grey Water |
| | Black Water |
| A/C Operational | Yes |
| | No |
| Status | Working |
| | Complete |
| | Adj Stopped |
| | Insd Stopped |
| | Mold - Work Stop |
| Rooms | Ifloor |
| | Type |
| | Description |
| Diagramming Dimensions | Length |
| | Width |
| | Height |
| Moisture Map | % Scale |
| | Point Scale |
| | Floor |
| | Walls |
| | Ceiling |
| Cover Type - Floor | Carpet |
| | Hard Surface |
| Cover Type - Walls | Drywall |
| | Panel |
| | Wood |
| | Plaster |
| | Vinyl |
| | Other |
| Cover Type - Ceiling | Drywall |
| | Wood |
| | Panel |
| | Vinyl |
| | Plaster |
| | Offsets (type, depth, width, |
| | height) |
| Room Connector | Dehu Sharing |
| | Rooms |
| | Connector Area |
| Room Readings - | Interior Temp |
| Moisture Goal | Interior RH (relative |
| | humidity) |
| | Exterior Temp |
| | Exterior RH |
| Affected Rooms | Temp |
| | RH |
| | Moisture Read (floor, wall, |
| | ceiling) |
| System Determines | Number of Air Movers |
| | Needed |
| | Number of Dehumidifiers |
| | Needed by Type |
| Equipment Scan | By Room |
| | Bar Codes |
| | Mfr - Type - Quantity |
| | Added to Estimate |
| Photos | Interior Rooms |
| | Equipment Setup |
| Estimate | Equipment |
| | Airmovers from Scan |
| | Dehu from Scan |
| | Line Item Details |
| | Scan from Bar Code List |
| Daily Readings | Room Readings |
| | Moisture Goal |
| | Interior Temp |
| | Interior RH |
| | Exterior Temp |
| | Exterior RH |
| | Affected Rooms |
| | Temp |
| | RH |
| | Moisture Read |
| | Floor-Wall-Ceiling |
| Complete | Customer Sign-Off |
| | Signature on Portable |
| | Device |

In another embodiment, each piece of equipment (e.g., air movers, dehumidifiers, and cavity dryers) includes an active RFID (radio frequency identification) module. This active RFID module is capable of communicating with portable device 110 automatically, thereby eliminating the need for the contractor to scan bar codes on the equipment. When the contractor enters the room and/or queries all equipment in the room, the various active RFID modules automatically respond by sending signal to portable device 110 identifying the equipment type, manufacturer, and so forth. If the equipment to which the active RFID module is attached can read temperature, humidity, or other parameters, that information is also communicated by the active RFID module (or by another communication mechanism in the device) to portable device 110. This embodiment allows the contractor to simply enter each room of the job site and automatically receive updated information into portable device 110. That information is then communicated to database 104 when portable device 110 is able to communicate via network 106.

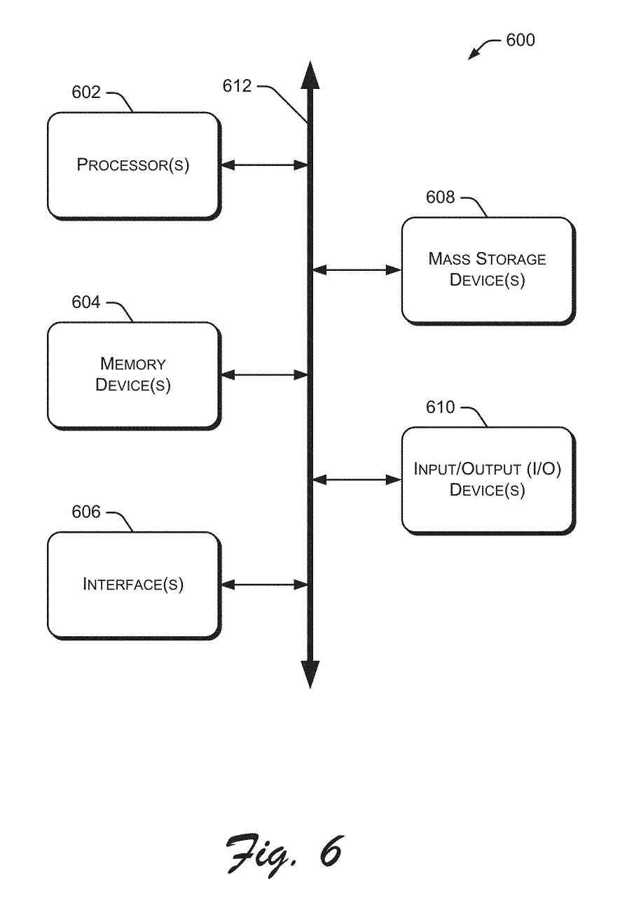

FIG. 6 is a block diagram illustrating an example computing device 600. Computing device 600 may be used to perform various procedures, such as those discussed herein. Computing device 600 can function as a server, a client, or any other computing entity. Computing device 600 can be any of a wide variety of computing devices, such as a desktop computer, a notebook computer, a server computer, a handheld computer, and the like.

Computing device 600 includes one or more processor(s) 602, one or more memory device(s) 604, one or more interface(s) 606, one or more mass storage device(s) 608, and one or more Input/Output (I/O) device(s) 610, all of which are coupled to a bus 612. Processor(s) 602 include one or more processors or controllers that execute instructions stored in memory device(s) 604 and/or mass storage device(s) 608. Processor(s) 602 may also include various types of computer-readable media, such as cache memory.

Memory device(s) 604 include various computer-readable media, such as volatile memory (e.g., random access memory (RAM)) and/or nonvolatile memory (e.g., read-only memory (ROM)). Memory device(s) 604 may also include rewritable ROM, such as Flash memory.

Mass storage device(s) 608 include various computer readable media, such as magnetic tapes, magnetic disks, optical disks, solid state memory (e.g., Flash memory), and so forth. Various drives may also be included in mass storage device(s) 608 to enable reading from and/or writing to the various computer readable media. Mass storage device(s) 608 include removable media and/or non-removable media.

I/O device(s) 610 include various devices that allow data and/or other information to be input to or retrieved from computing device 600. Example I/O device(s) 610 include cursor control devices, keyboards, keypads, microphones, monitors or other display devices, speakers, printers, network interface cards, modems, lenses, CCDs or other image capture devices, and the like.

Interface(s) 606 include various interfaces that allow computing device 600 to interact with other systems, devices, or computing environments. Example interface(s) 606 include any number of different network interfaces, such as interfaces to local area networks (LANs), wide area networks (WANs), wireless networks, and the Internet.

Bus 612 allows processor(s) 602, memory device(s) 604, interface(s) 606, mass storage device(s) 608, and I/O device(s) 610 to communicate with one another, as well as other devices or components coupled to bus 612. Bus 612 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 600, and are executed by processor(s) 602. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A portable device comprising:
a processor;
a wireless transceiver coupled to the processor and configured for cellular phone communications; and
a reader coupled to the processor and configured to detect equipment identifiers that distinguish multiple items of equipment from one another, wherein the reader provides fast detection of equipment identifiers.

2. The portable device of claim 1 wherein the reader is a bar code reader.

3. The portable device of claim 1 wherein the portable device is configured to determine equipment capabilities based on the detected equipment identifiers.

4. The portable device of claim 1 further comprising a touch-sensitive screen configured to allow expedited and efficient data entry by a user of the portable device.

5. The portable device of claim 1 further comprising a touch-sensitive screen and a keypad, wherein the touch-sensitive screen and the keypad are configured to allow simultaneous data entry by a user of the portable device using both the touch-sensitive screen and the keypad.

6. The portable device of claim 1 further comprising a humidity sensor incorporated into the portable device and configured to determine a current relative humidity proximate the portable device.

7. The portable device of claim 1 further comprising a temperature sensor incorporated into the portable device and configured to determine a current temperature proximate the portable device.

8. The portable device of claim 1 wherein the reader is a radio frequency id (RFID) reader.

9. The portable device of claim 8 wherein the portable device is configured to receive RFID information, from the RFID reader, associated with equipment identifiers that distinguish different items of water damage mitigation equipment from one another.

10. The portable device of claim 8 wherein the portable device is configured to automatically receive RFID information, from the RFID reader, associated with equipment in a room when the portable device is within the room, wherein the RFID information is associated with equipment identifiers that distinguish different items of water damage mitigation equipment from one another.

11. The portable device of claim 1 wherein the wireless transceiver is further configured for wi-fi communications.

12. The portable device of claim 1 wherein the reader communicates the detected equipment identifiers to the processor.

13. The portable device of claim 1 wherein the wireless transceiver is further configured to receive job assignment information, transmit information associated with a job site, and receive information regarding appropriate equipment to use at the job site.

14. A method comprising:
receiving a job assignment into a portable device having a wireless transceiver configured for cellular phone communications;
diagramming a job site associated with the job assignment using the portable device; and
receiving, from a reader in the portable device, detected equipment identifiers that identify multiple items of equipment from one another, wherein the multiple items of equipment are located at the job site.

15. The method of claim 14 wherein diagramming the job site includes identifying a location of each of the multiple items of equipment located at the job site.

16. The method of claim 14 further comprising identifying job site humidity readings using a humidity sensor incorporated into the portable device and configured to determine a current relative humidity proximate the portable device.

17. The method of claim 14 further comprising identifying job site temperature readings using a temperature sensor incorporated into the portable device and configured to determine a current temperature proximate the portable device.

18. The method of claim 14 wherein the reader is a bar code reader.

19. The method of claim 14 wherein the reader is an RFID receiver, and wherein the portable device receives RFID information associated with equipment identifiers that distinguish different items of water mitigation damage equipment from one another.

20. The method of claim 14 wherein the reader is an RFID receiver, wherein the portable device automatically receives RFID information associated with equipment in a room when the portable device is within the room, and wherein the RFID information is associated with equipment identifiers that distinguish different items of water damage mitigation equipment from one another.
